(19) United States
(12) Patent Application Publication
(10) Pub. No.: US 2011/0216419 A1
(43) Pub. Date: Sep. 8, 2011

(54) ERECTING AND UNITY-MAGNIFYING LENS ARRAY AND CONTACT IMAGE SENSOR

(75) Inventor: Takashi SHIRAISHI, Kanagawa-ken (JP)

(73) Assignees: Kabushiki Kaisha Toshiba, Tokyo (JP); Toshiba Tec Kabushiki Kaisha, Tokyo (JP)

(21) Appl. No.: 13/040,223

(22) Filed: Mar. 3, 2011

Related U.S. Application Data
(60) Provisional application No. 61/310,635, filed on Mar. 4, 2010.

(51) Int. Cl. G02B 27/12

(52) U.S. Cl. 359/622

(57) ABSTRACT

An erecting and unity-magnifying lens array includes: a first lens array plate that has a plurality of first lenses, a second lens array plate that has a plurality of second lenses, a third lens array plate that has a plurality of third lenses, a first aperture plate that has a plurality of round holes formed therein, that is disposed between the first lens array plate and the second lens array plate, and that has a first thickness; and a second aperture plate that has a plurality of round holes formed therein, that is disposed close to the exit surface of the second lens array plate, that is disposed so that vertexes of the exit surfaces of the plurality of second lenses are located inside the plurality of round holds, and that has a second thickness smaller than the first thickness.

### CROSS-REFERENCE TO RELATED APPLICATION(S)

This application is based upon and claims the benefit of priority from: U.S. provisional application 61/310,635, filed on Mar. 4, 2010; the entire contents all of which are incorporated herein by reference.

### FIELD

The embodiments described in this specification relate to a technique of preventing stray light from being generated in an erecting and unity-magnifying lens array.

### BACKGROUND

An erecting and unity-magnifying lens array in which plural lens array plates having plural lenses arranged in a direction perpendicular to an optical axis are arranged in the optical axis direction has been known in the related art.

The erecting and unity-magnifying lens array is provided with apertures so that light passing through a lens does not enter lenses corresponding to neighboring optical axes other than an optical axis of the lens as stray light.

However, it is difficult to reduce noise which the generated stray light applies to an image in the erecting and unity-magnifying lens array.

### DESCRIPTION OF THE DRAWINGS

FIG. 1 is an exploded perspective view illustrating an erecting and unity-magnifying lens array Q according to a first embodiment of the invention.

FIG. 2 is a sectional view taken along a z-y plane, in which a part of the erecting and unity-magnifying lens array Q according to the first embodiment of the invention is shown.

FIG. 3 is a diagram illustrating the minimum thickness of a first aperture plate necessary for suppressing stray light.

FIG. 4 is a diagram illustrating a state where stray light reaches a planar portion of a second lens array plate.

FIG. 5 is a diagram illustrating a state where stray light is generated in the erecting and unity-magnifying lens array according to the first embodiment.

FIG. 6 is a longitudinal sectional view schematically illustrating a configurational example of an image forming apparatus mounted with the erecting and unity-magnifying lens array according to the first embodiment.

FIG. 7 is a longitudinal sectional view schematically illustrating a configurational example in which the erecting and unity-magnifying lens array according to the first embodiment is provided as a reading head of a scanner.

FIG. 8 is a longitudinal sectional view schematically illustrating a configurational example in which the erecting and unity-magnifying lens array according to the first embodiment is provided as a writing optical element guiding a LED light to a photoconductive member.

FIG. 9 is a diagram illustrating an advantage of the configuration in which a radius of an opening of a round hole close to a first lens array plate is smaller than a radius of a peripheral edge on an exit surface of a first lens.

FIG. 10 is a diagram illustrating the configuration in which lenses are disposed on an entrance surface of a first lens array plate and an exit surface of a third lens array plate.

FIG. 11 is a diagram illustrating a state where stray light is generated in an erecting and unity-magnifying lens array according to the related art.

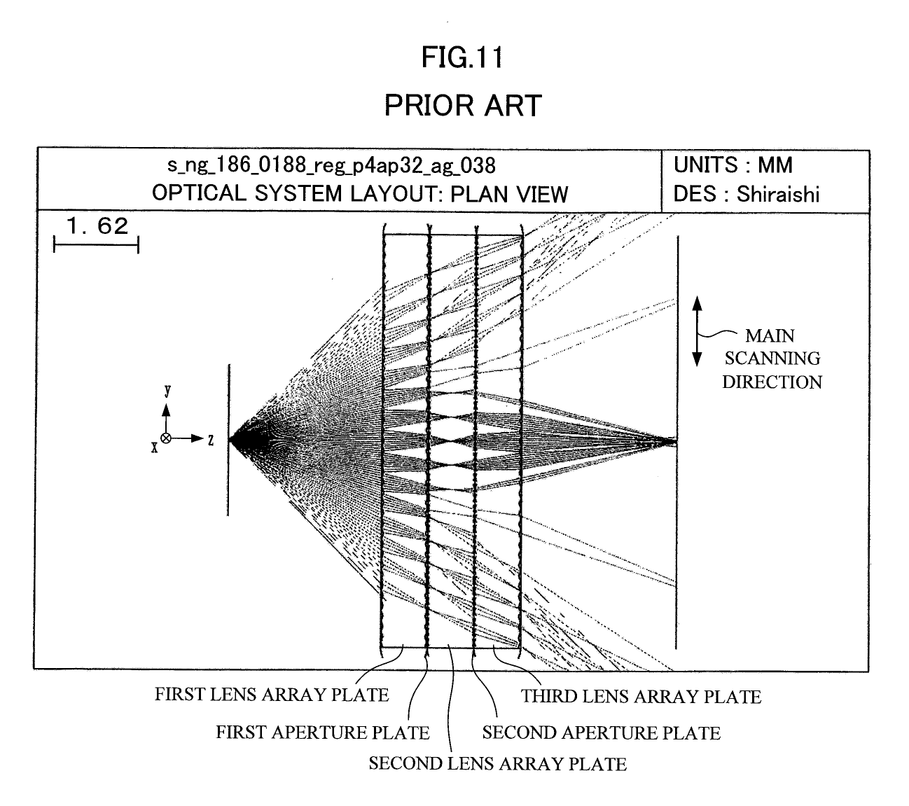

### DETAILED DESCRIPTION

According to an embodiment of the invention, an erecting and unity-magnifying lens array generally includes a first lens array plate, a second lens array plate, a third lens array plate, a first aperture plate, and a second aperture plate.

The first lens array plate has a plurality of first lenses, of which exit surfaces are convex, arranged in a direction perpendicular to an optical axis.

The second lens array plate has a plurality of second lenses, of which entrance surfaces and the exit surfaces are convex, arranged in the direction perpendicular to the optical axis so as to correspond to the plurality of first lenses, and a light beam emitted from the exit surface of each lens of the first lens array plate is incident thereon.

The third lens array plate has a plurality of third lenses, of which the entrance surfaces are convex, arranged in the direction perpendicular to the optical axis so as to correspond to the plurality of first lenses.

The first aperture plate has a plurality of round holes formed therein to correspond to the plurality of first lenses and the plurality of second lenses, is disposed between the first lens array plate and the second lens array plate, and has a first thickness.

The second aperture plate has a plurality of round holes formed therein to correspond to the plurality of second lenses and the plurality of third lenses, is disposed in the vicinity of the exit surface of the second lens array plate so that vertexes of the exit surfaces of the plurality of second lenses are located inside the plurality of round holes, and has a second thickness smaller than the first thickness.

Hereinafter, embodiments of the invention will be described with reference to the accompanying drawings.

### First Embodiment

First, a first embodiment of the invention will be described.

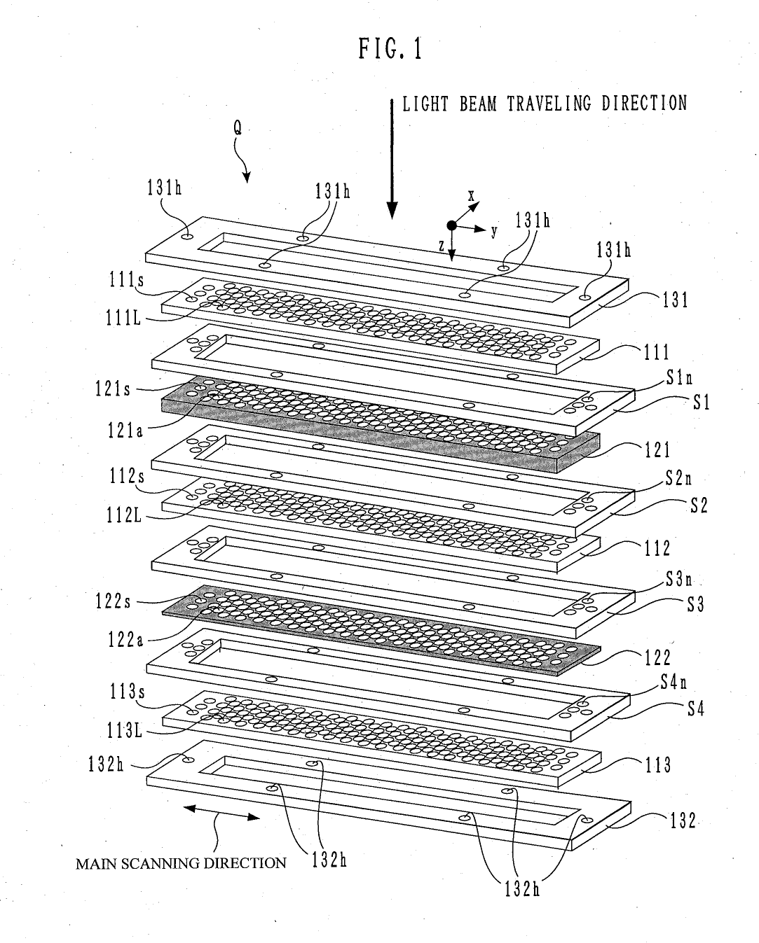

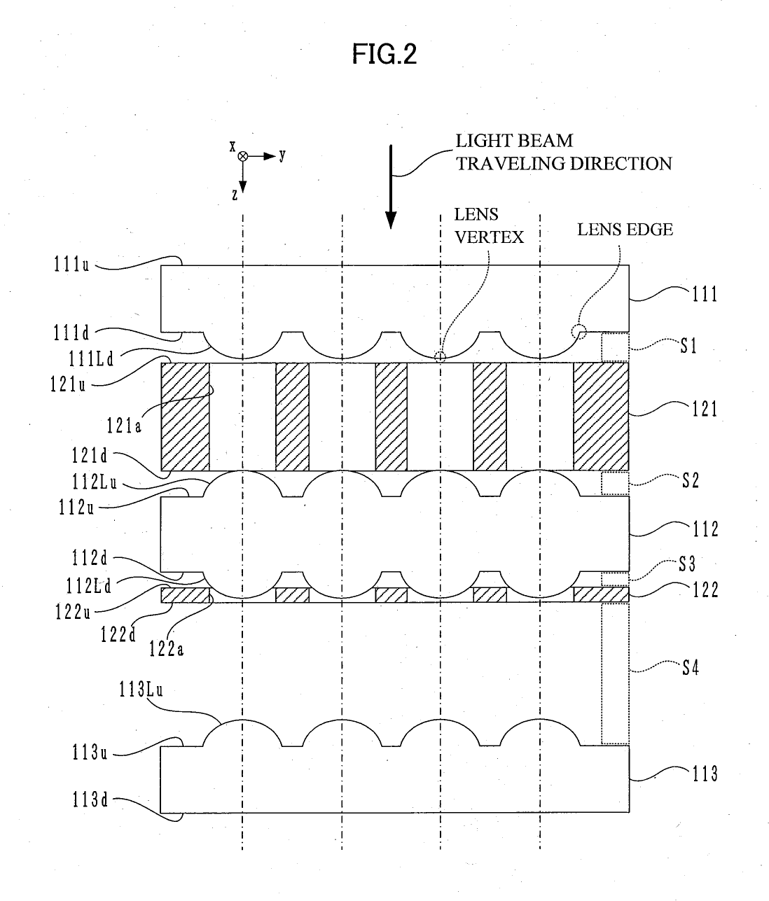

FIG. 1 is an exploded perspective view illustrating an erecting and unity-magnifying lens array Q according to the first embodiment of the invention. FIG. 2 is a sectional view taken along a z-y plane in which a part of the erecting and unity-magnifying lens array Q according to the first embodiment is shown.

The erecting and unity-magnifying lens array Q according to the first embodiment includes a first lens array plate 111, a second lens array plate 112, a third lens array plate 113, a first aperture plate 121, a second aperture plate 122, spacers S1 to S4, and retainer plates 131 and 132.

The constituent elements of the erecting and unity-magnifying lens array Q according to this embodiment are arranged in the traveling direction of a light beam in the order of the retainer plate 131, the first lens array plate 111, the spacer S1, the aperture plate 121, the spacer S2, the second lens array plate 112, the spacer S3, the aperture plate 122, the spacer S4, the third lens array plate 113, and the retainer plate 132.

The first lens array plate 111, the spacer S1, the aperture plate 121, the spacer S2, the second lens array plate 112, the spacer S3, the aperture plate 122, the spacer S4, and the third lens array plate 113 are fixed to each other between the retainer plate 131 and the retainer plate 132 by bolts or screws inserted into screw positioning holes 131h and holes 132h.

On surfaces, which are opposed to the spacers, of the first lens array plate 111, the aperture plate 121, the second lens array plate 112, the aperture plate 122, and the third lens array plate 113, protrusions (for example, a convex lens shape) ills, 121s, 112s, 122s, and 113s are formed at positions corresponding to positioning holes S1n and S4n formed in the spacers S1 to S4.

By inserting the protrusions 111s, 121s, 112s, 122s, and 113s into the holes S1n to S4n of the spacers at the time of placing the first lens array plate 111, the spacer S1, the aperture plate 121, the spacer S2, the second lens array plate 112, the spacer S3, the aperture plate 122, the spacer S4, and the third lens array plate 113 between the retainer plates 131 and 132, a relative positioning of the first lens array plate 111, the aperture plate 121, the second lens array plate 112, the aperture plate 122, and the third lens array plate 113 in the direction perpendicular to the optical axis can be carried out.

The spacers S1 to S4 serves to relatively position the first lens array plate 111, the aperture plate 121, the second lens array plate 112, the aperture plate 122, and the third lens array plate 113 in the optical axis direction.

In this way, by performing the positioning of the lenses and the apertures using the portions having the same shape as the lenses, the portions used in the positioning can be formed at the same time as forming the lens array plates, thereby contributing to improvement in precision for relatively positioning the lenses and the portions used in the positioning and decrease in manufacture cost.

Here, the configuration in which the protrusions are formed in the lens array plates and the aperture plates and the holes are formed in the spacers is exemplified, but the invention is not limited to this configuration. For example, the protrusions may be formed in the spacers and the holes may be formed in the lens array plates and the aperture plates. The portions into which the protrusions are inserted are not necessarily the holes, but may be concave portions (for example, a concave lens shape).

In this embodiment, entrance surfaces of the lenses constituting the first lens array plate 111 and exit surfaces of the lenses constituting the third lens array plate 113 are planar. By employing this configuration, it is possible to prevent a light beam from being refracted by a refractive power face of the lens surface and reaching a neighboring lens to serve as stray light in the first lens array plate and the third lens array plate.

Since the entrance surface of the first lens array plate does not have a refractive power function, the light beam incident on the first lens array plate contacts the refractive power face at a position of the exit surface at the first time. Since the exit surface of the third lens array plate does not have a refractive power function, the light beam is refracted by the refractive power face at a position of the entrance surface and does not enter a neighboring refractive power lens.

The reasons for setting both the entrance surface of the first lenses and the exit surface of the third lenses to be planar are as follows.

(1) In general, it is considered that a lens arrangement symmetric in the optical axis direction is preferable for optically designing a unity-magnifying lens system.

(2) When a manufacturing difference is generated in the first lenses, the second lenses, and the third lenses and when the exit surfaces of the third lenses determining a final image forming position of a light beam have a refractive power function, an image may be formed at a position greatly departing from an intended image forming position.

(3) By setting the first lens array plate and the third lens array plate to have symmetric shapes, a mold can be commonly used to manufacture the lens array plates, thereby greatly reducing the manufacture cost.

In the first lens array plate 111, plural first lenses 111L of which the exit surfaces are convex are arranged in the direction (in the x-y plane direction) perpendicular to the optical axis (see FIG. 1).

In the second lens array plate 112, plural second lenses 112L of which the entrance surfaces and the exit surfaces are convex are arranged in the direction (in the x-y plane direction) perpendicular to the optical axis so as to correspond to the first lenses 111L (see FIG. 1). The light beam emitted from the exit surface of each lens of the first lens array plate is incident thereon.

In the third lens array plate 113, plural third lenses 113L of which the entrance surfaces are convex are arranged in the direction (in the x-y plane direction) perpendicular to the optical axis so as to correspond to the first lenses 111L (see FIG. 1).

In the first aperture plate 121, plural round holes 121a corresponding to the first lenses 111L and the second lenses 112L are formed. The first aperture plate is disposed between the first lens array plate 111 and the second lens array plate 112 and has a first thickness (tap1 to be described later).

In the second aperture plate 122, plural round holes 122a corresponding to the second lenses 112L and the third lenses 113L are formed. The second aperture plate is disposed in the vicinity of the exit surface (downstream in the light beam traveling direction) of the second lens array plate 112 so that the vertexes of exit surfaces 112Ld of the plural second lenses 112L are located inside the plural round holes 122a and has a second thickness (tap2 to be described later) smaller than the first thickness (tap1 to be described later).

As shown in FIG. 2, a gap exists in the light beam traveling direction between a lens edge of the first lens array plate 111 and a surface 121u of the first aperture plate 121 upstream in the light beam traveling direction. A radius of the lens edge is greater than an opening radius r2 of the holes 121a of the first aperture plate 121 upstream in the light beam traveling direction (on the side close to the first lens array plate 111).

In this way, the erecting and unity-magnifying lens array Q according to this embodiment includes only the first aperture plate 121 and the second aperture plate 122 as aperture plates in the light beam traveling direction. That is, no aperture plate is disposed upstream in the light beam traveling direction and downstream in the light beam traveling direction of the third lens array plate 113.

In the first embodiment, the number of aperture plates arranged is the smallest. The second aperture plate 122 may have the same thickness as the first aperture plate 121 or the second aperture plate 122 may have a thickness equal to or greater than that of the first aperture plate 121. An aperture plate may be disposed on at least one of the upstream side in the light beam traveling direction and the downstream side in the light beam traveling direction of the third lens array plate 113.

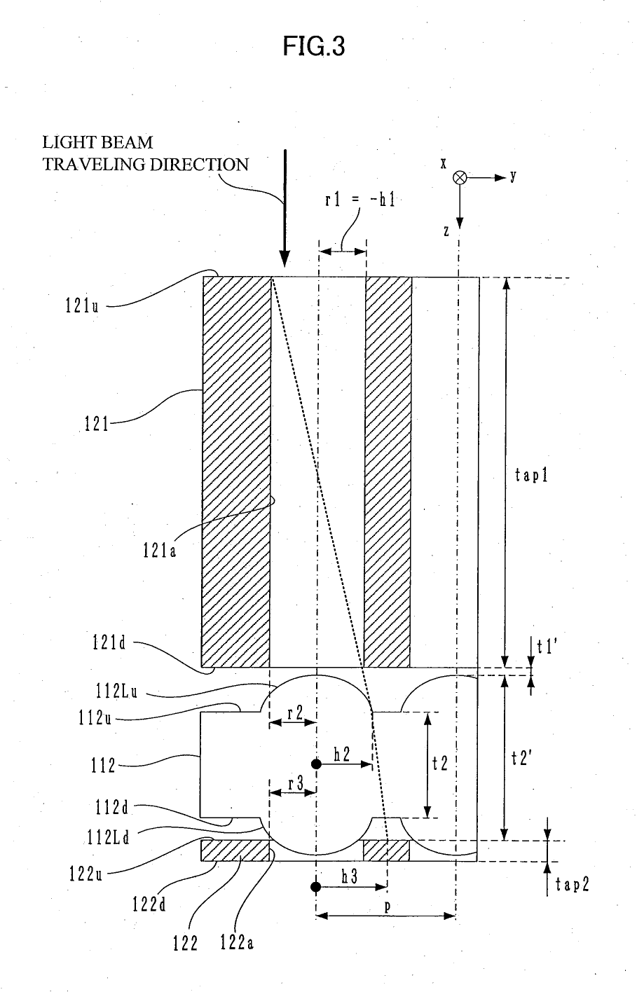

The minimum thickness tap1 necessary for the first aperture plate 121 so as not to generate stray light will be described below with reference to FIG. 3 by use of paraxial beam tracking.

Here, when tap1 represents the thickness of the first aperture plate 121, r1 represents a radius of an opening of each round hole 121a in the first aperture plate 121 close to the first lens array plate 111, r2 represents the radius of the opening of each round hole 121a in the first aperture plate 121 close to the second lens array plate 112, r3 represents a radius of an opening of each round hole 122a in the second aperture plate 122 close to the second lens array plate 112, t1′ represents a distance between an exit surface 121d of the first aperture plate 121 and a lens vertex of each second lens entrance surface 112Lu, t2′ represents a distance between the lens vertex of each second lens entrance surface 112Lu of the second lens array plate 112 and the entrance surface 122u of the second aperture plate 122, and p represents a distance (lens pitch) between the vertexes of the neighboring first lenses 111L in the first lens array plate 111, and when stray light reaches the entrance surface 112Lu of the lens 112L of the second lens array plate 112, a light beam height h1 and an angle α1 at the entrance-side opening of each hole 121a of the first aperture plate 121 are expressed by the following Expressions.

h1=−r1 Expression 1

α1=(r1+r2)/tap1 Expression 2

A light beam height h2 and an angle α2 at the planar portion of the second lens array plate 112 are expressed by the following Expressions.

h2=h1+α1×(tap1+t1′) Expression 3

α2=α1−φ×h2 Expression 4

Here, φ represents a power of each second lens entrance surface 112Lu.

When the second aperture plate 122 contacts the second lens exit surfaces 112Ld of the second lens array plate 112 (where the stray light is most hardly generated), the light beam height on the entrance surface 122u of the second aperture plate 122 needs to be affected by vignetting by the second aperture plate 122 and needs to satisfy the following Expression.

h3=h2+α2×t2′/n>p−r3 Expression 5

By solving these Expressions with respect to tap1, the following Expression is obtained.

tap1>(r1+r2)×(t1′+t2′/n−φ×t1′×t2′/n)/(p−r2−r3+φ×t1′×t2′/n) Expression 6

This Expression is the smallest at t1′=0.

Then, the following Expression is obtained.

tap1>(r1+r2)×t2′/n/(p−r2−r3) Expression 7

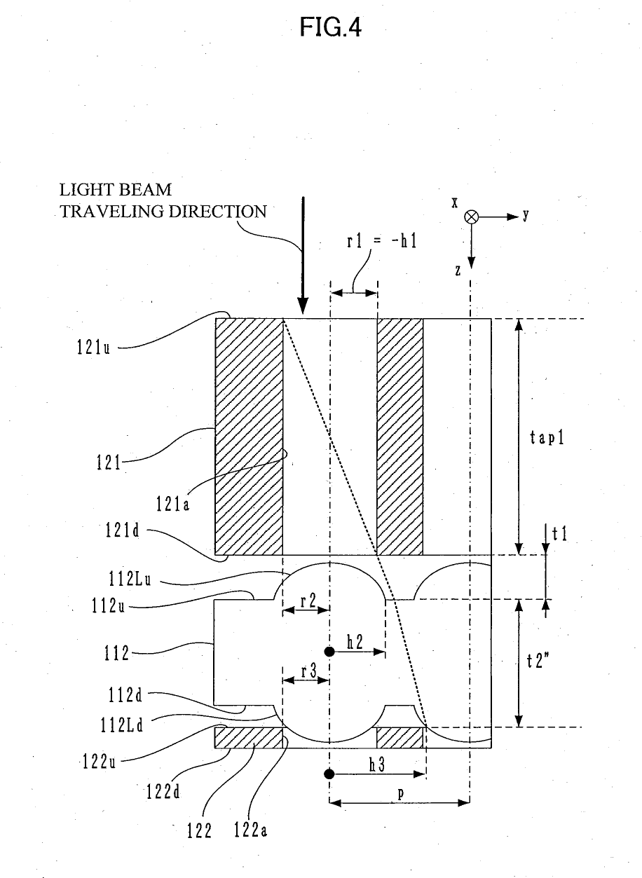

Subsequently, the state where stray light reaches the planar portion of the second lens array plate 112 will be described with reference to FIG. 4.

Here, it is assumed that t1 represents a distance between the exit surface 121d of the first aperture plate 121 and the planar portion of an entrance surface 112u of the second lens array plate 112 and t2″ represents a distance between the planar portion of the entrance surface 112u of the second lens array plate 112 and the entrance surface 122u of the second aperture plate 122.

The light beam height h1 and the angle α1 at the opening upstream in the light beam traveling direction of the round holes 121a of the first aperture plate 121 are expressed by the following Expressions.

h1=−r1 Expression 8

α1=(r1+r2)/tap1 Expression 9

The light beam height h2 and the angle α2 at the planar portion of the second lens array plate 112 are expressed by the following Expressions.

h2=h1+α1×(tap1+t1) Expression 10

α2=α1 Expression 11

When the second aperture plate 122 contacts the second lens exit surfaces 112Ld of the second lens array plate 112 (where the stray light is most hardly generated), the light beam height on the surface of the aperture plate needs to be affected by vignetting by the round holes 122a of the second aperture plate 122 and thus needs to satisfy the following Expression.

h3=h2+α2×t2″/n<p−r3 Expression 12

By solving these Expressions with respect to tap1, the following Expression is obtained.

tap1>(r1+r2)×(n×t1+t2″)/n/(p−r2−r3) Expression 13

This Expression is the smallest at t1′=0.

Then, the following Expression is obtained.

tap1>(r1+r2)×t2″/n/(p−r2−r3) Expression 14

In Expression 14, “t2′” in Expression 7 is replaced with “t2””.

When t2 is defined as the thickness of the thinnest in the optical axis direction of a portion between the plural second lenses 112L of the second lens array plate 112 and n is defined as a refractive index of the first lens array plate 111, the right side of the above Expression is smaller in value than the right side of the conditional Expression of tap1 and thus can be expressed by the following Expression.

tap1>(r1+r2)×t2/n/(p−r2−r3) Expression 15

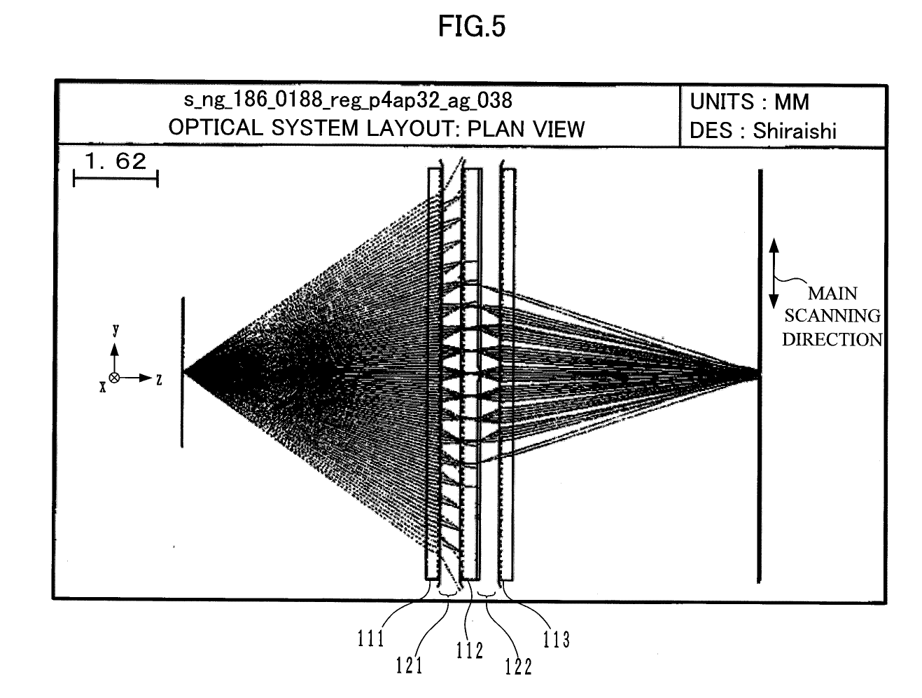

FIG. 5 is a diagram illustrating a state where stray light is generated in the erecting and unity-magnifying lens array according to the first embodiment.

As shown in the drawing, it can be seen that the generation of stray light is effectively suppressed in the erecting and unity-magnifying lens array Q according to the first embodiment.

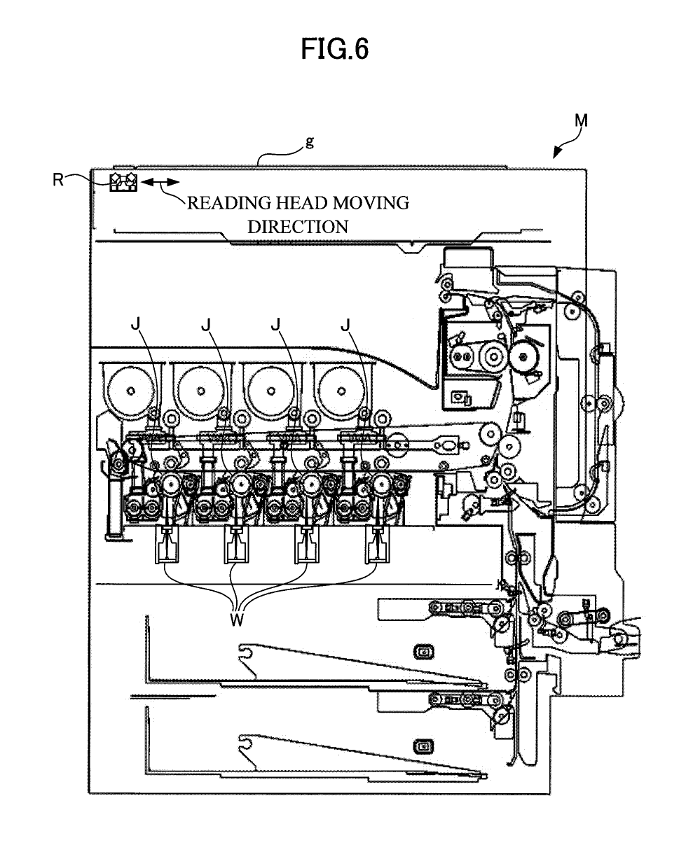

FIG. 6 is a longitudinal sectional view schematically illustrating a configurational example of an image forming apparatus in which the erecting and unity-magnifying lens array Q according to the first embodiment is mounted as a reading head R of a scanner and as a writing optical system W forming an electrostatic latent image on a photoconductive member J by use of a LED light.

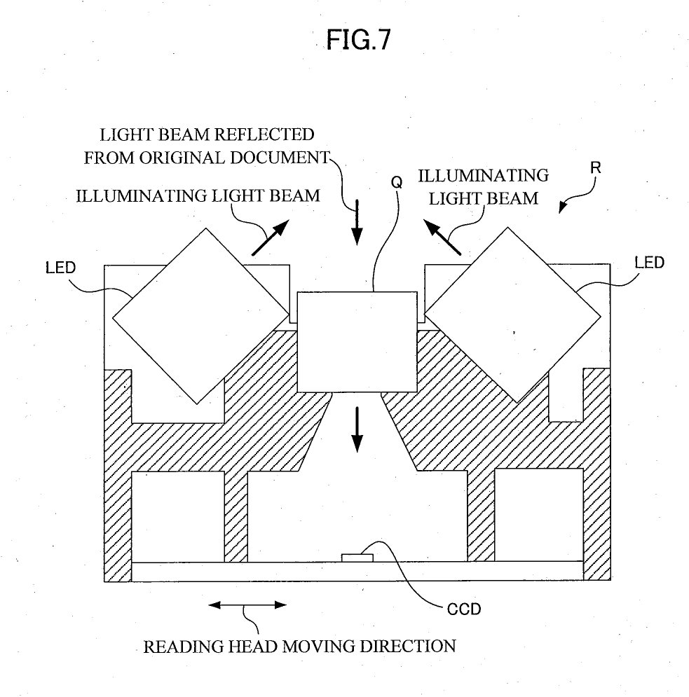

FIG. 7 is a longitudinal sectional view schematically illustrating a configurational example in which the erecting and unity-magnifying lens array Q according to the first embodiment is provided as the reading head R (a contact image sensor) of the scanner.

An LED as a light source emits illumination light illuminating an original document placed on a platen glass g.

A CCD as alight-receiving device receives a light beam reflected by the original document and guided by the erecting and unity-magnifying lens array Q.

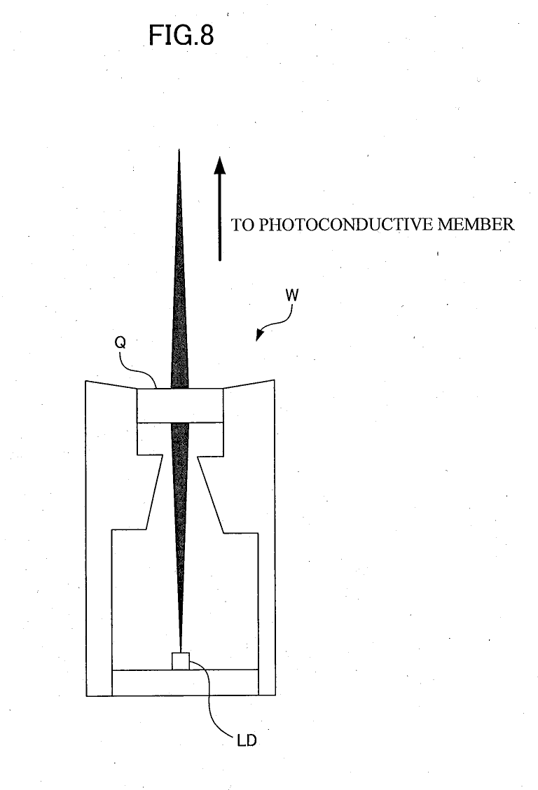

FIG. 8 is a longitudinal sectional view schematically illustrating a configurational example in which the erecting and unity-magnifying lens array Q according to the first embodiment is provided as a writing optical device guiding a LED light to the photoconductive member.

An LED as a light source emits a light beam to the erecting and unity-magnifying lens array Q.

An electrostatic latent image is formed on the photoconductive member J by the light beam emitted from the erecting and unity-magnifying lens array Q.

According to the above-mentioned first embodiment of the invention, for example, the following configuration can be provided.

(1) An image forming apparatus including: an erecting and unity-magnifying lens array; a light source that emits an illuminating light beam to the erecting and unity-magnifying lens array; and a photoconductive member on which an electrostatic latent image is formed by the light beam emitted from the erecting and unity-magnifying lens array, wherein the erecting and unity-magnifying lens array includes a first lens array plate that has a plurality of first lenses, of which exit surfaces are convex, arranged in a direction perpendicular to an optical axis, a second lens array plate that has a plurality of second lenses, of which entrance surfaces and the exit surfaces are convex, arranged in the direction perpendicular to the optical axis so as to correspond to the plurality of first lenses and that has a light beam emitted from the exit surface of each lens of the first lens array plate be incident thereon, a third lens array plate that has a plurality of third lenses, of which the entrance surfaces are convex, arranged in the direction perpendicular to the optical axis so as to correspond to the plurality of first lenses, a first aperture plate that has a plurality of round holes formed therein to correspond to the plurality of first lenses and the plurality of second lenses, that is disposed between the first lens array plate and the second lens array plate, and that has a first thickness, and a second aperture plate that has a plurality of round holes formed therein to correspond to the plurality of second lenses and the plurality of third lenses, that is disposed close to the exit surface of the second lens array plate, that is disposed so that vertexes of the exit surfaces of the plurality of second lenses are located inside the plurality of round holds, and that has a second thickness smaller than the first thickness.

### Second Embodiment

A second embodiment of the invention will be described below.

The second embodiment is a modification of the first embodiment. Hereinafter, the elements having the same functions as described in the first embodiment are referenced by the same reference numerals and signs and description thereof is not repeated.

When a gap exists in the optical axis direction between the peripheral edges of the first lenses 111L of the first lens array plate 111 and the first aperture plate 121 and when the aperture plate is not disposed adjacent to the peripheral edges of the first lenses 111L of the first lens array plate 111 (that is, it is disposed with a predetermined gap therebetween), it is preferable that the radius of the peripheral edge of each first lens 111L is set to be greater than a predetermined value (that is, the opening radius of each round hole 121a close to the first lens array plate 111 is smaller than the radius of each peripheral edge of an exit surface 111Ld of each first lens 111L). Accordingly, it is possible to block scattered light generated in the peripheral edges of the first lenses 111L by the use of the first aperture plate 121.

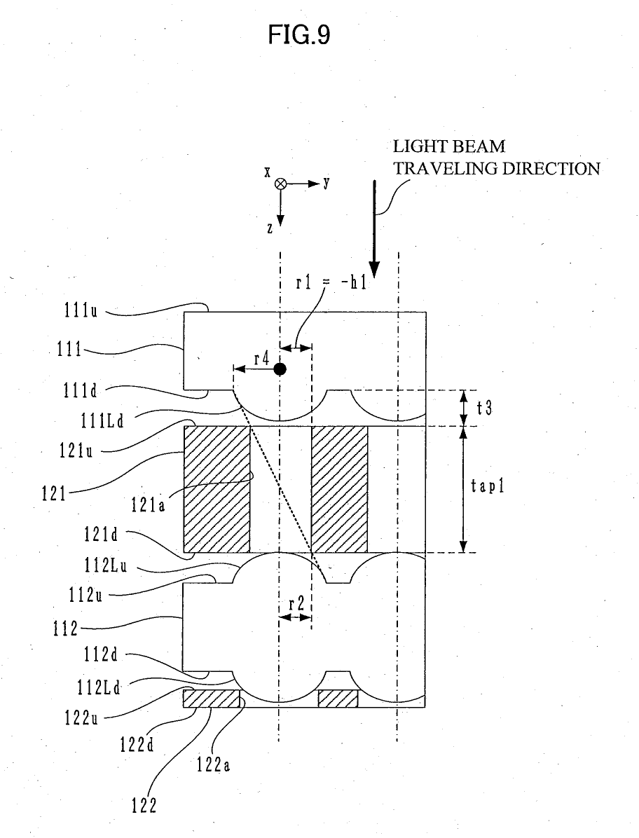

This will be described with reference to FIG. 9.

When stray light reaches the entrance surface 112Lu of each second lens 112L of the second lens array plate 112, the following Expressions are established at the position where the stray light is generated.

h1=−r4 Expression 16

α1=(r4−r1)·/t3 Expression 17

The light beam height h2 and the angle α2 at the entrance surface 121u of the first aperture plate are expressed by the following Expressions.

h2=h1+α1×t×3 Expression 18

α2=α1 Expression 19

Since the light beam height h3 at the exit surface 121d of the first aperture plate needs to be greater than the opening radius r2 of each round hole 121a in the exit surface of the first aperture plate 121, the following Expression has to be satisfied.

h3=h2+α2×tap1>r2 Expression 20

By solving this Expression with respect to tap1, the following Expression is obtained.

tap1>t3×(r2+r1)/(r4−r1) Expression 21

When the thickness tap1 of the first aperture plate 121 is fixed, a radius r4 of the peripheral edge on the exit surface 111Ld of each first lens 111L has to satisfy the following Expression.

r4>t3×(r2+r1)/tap1+r1 Expression 22

Here, t3 represents a distance between the peripheral edge on the exit surface 111Ld of each first lens 111L and the first aperture plate 121, r2 represents the opening radius of each round hole 121a of the first aperture plate 121 close to the second lens array plate 112, r1 represents the opening radius of each round hole 121a of the first aperture plate 121 close to the first lens array plate 111, and tap1 represents the thickness (the first thickness) of the first aperture plate 121.

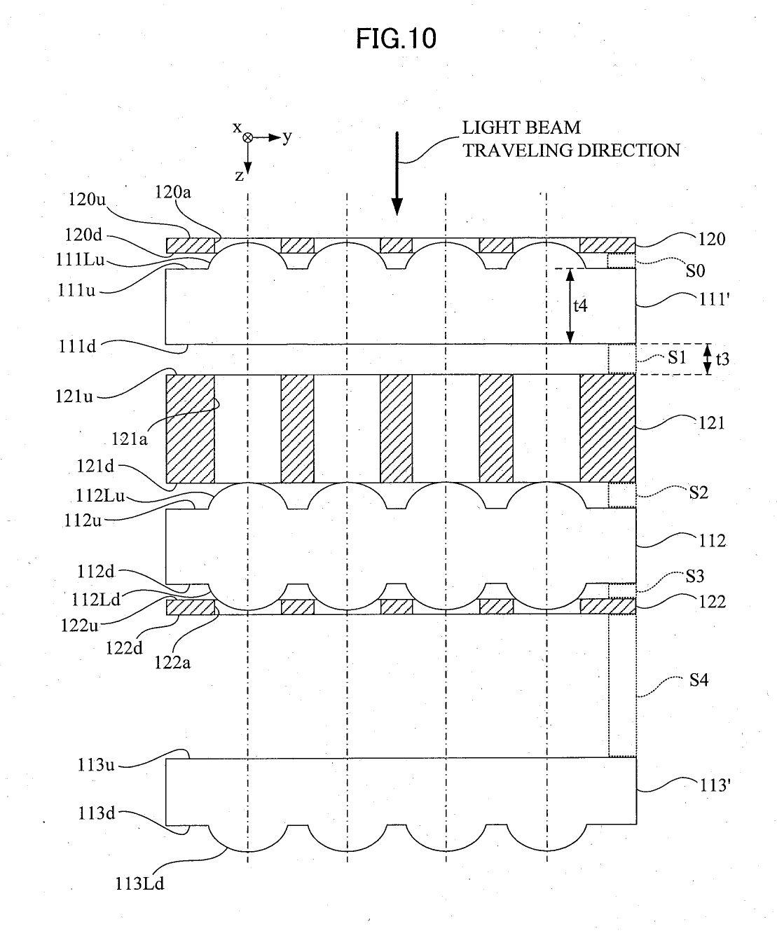

As shown in FIG. 10, when lenses 111Lu exist on the entrance surface of the first lens array plate 111′ and the exit surface 111d of the first lens array plate 111′ is planar and when a distance between the peripheral edge of the entrance surface 111Lu of each first lens 111L and the exit surface 111d of the first lens array plate 111′ is defined as t4, the following Expression is obtained.

r4>(t4/n+t3)×(r2+r1)/tap1+r1 Expression 23

Here, n represents a refractive index of the first lens array plate, t3 represents the distance between the planar portion of the exit surface 111d of each first lens 111L and first aperture plate 121, r2 represents the opening radius of each round hole 121a of the first aperture plate 121 close to the second lens array plate 112, r1 represents the opening radius of each round hole 121a of the first aperture plate 121 close to the first lens array plate 111, and tap1 represents the thickness (the first thickness) of the first aperture plate 121.

Here, r2, r1, and tap1 are the same as shown in FIG. 9 and thus are not shown in FIG. 10.

According to the above-mentioned second embodiment, for example, the following configuration can be provided.

(1) An image forming apparatus including: an erecting and unity-magnifying lens array; a light source that emits a light beam to the erecting and unity-magnifying lens array; and a photoconductive member on which an electrostatic latent image is formed by the light beam emitted from the erecting and unity-magnifying lens array, wherein the erecting and unity-magnifying lens array includes a first lens array plate that has a plurality of first lenses of which exit surfaces are convex, arranged in a direction perpendicular to an optical axis; a second lens array plate that has a plurality of second lenses, of which entrance surfaces and the exit surfaces are convex, arranged in the direction perpendicular to the optical axis so as to correspond to the plurality of first lenses and that has a light beam emitted from the exit surface of each lens of the first lens array plate be incident thereon; a third lens array plate that has a plurality of third lenses of which the entrance surfaces are convex, arranged in the direction perpendicular to the optical axis so as to correspond to the plurality of first lenses; and a first aperture plate that has a plurality of round holes formed therein to correspond to the plurality of first lenses and the plurality of second lenses and that is disposed downstream in a light beam traveling direction of the first lens array plate with a predetermined distance interposed between the peripheral edge of each exit surface of the plurality of first lenses and the first aperture plate, in which a radius of each opening of the plurality of round holes close to the first lens array plate is smaller than a radius of the peripheral edge of the exit surface of each first lens.

As described above, according to the first and second embodiments, it is possible to reduce the thickness of the aperture plates and to block the stray light.

In general, an operation of printing an aperture shape by screen print or the like is repeated several times at the time of forming the aperture plate and several printed layers are superposed, whereby an aperture plate with a desired thickness can be formed.

For example, when the screen print is used, the thickness of the printed layer which can be formed by one printing operation is about 100 μm. In order to superpose several layers, a subsequent printing operation needs to be performed after the previous printed layer is dried and the number of processes increases as the number of layers to be superposed increases, thereby causing an increase in cost.

On the other hand, a punching method using a press is also known as the method of forming an aperture plate. However, when this method is used but when holes with a small diameter are formed or the distance between the neighboring holes is small, the thickness of a sheet to be pressed has to be small. Accordingly, when it is intended to form a thick aperture plate, an operation of superposing several thin sheets of an aperture shape has to be carried out, thereby causing an increase in cost.

Therefore, by reducing the thickness of an aperture plate using the technique shown in the first and second embodiments, it is possible to reduce the total thickness of apertures used in an erecting and unity-magnifying lens array while suppressing the generation of stray light, thereby reducing the number of manufacture processes.

As described above in detail, according to the techniques described in this specification, it is possible to provide a technique of reducing the total thickness of aperture plates used in an erecting and unity-magnifying lens array while suppressing the generation of stray light.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and spirit of the inventions.

What is claimed is:

1. An erecting and unity-magnifying lens array comprising:
a first lens array plate that has a plurality of first lenses, of which exit surfaces are convex, arranged in a direction perpendicular to an optical axis;
a second lens array plate that has a plurality of second lenses, of which entrance surfaces and the exit surfaces are convex, arranged in the direction perpendicular to the optical axis so as to correspond to the plurality of first lenses and that has a light beam emitted from the exit surface of each lens of the first lens array plate be incident thereon;
a third lens array plate that has a plurality of third lenses, of which the entrance surfaces are convex, arranged in the direction perpendicular to the optical axis so as to correspond to the plurality of first lenses;
a first aperture plate that has a plurality of round holes formed therein to correspond to the plurality of first lenses and the plurality of second lenses, that is disposed between the first lens array plate and the second lens array plate, and that has a first thickness; and
a second aperture plate that has a plurality of round holes formed therein to correspond to the plurality of second lenses and the plurality of third lenses, that is disposed in the vicinity of the exit surface of the second lens array plate, and that has a second thickness smaller than the first thickness.

2. The lens array according to claim 1, wherein the plurality of first lenses in the first lens array plate each have a planar entrance surface.

3. The lens array according to claim 1, wherein only the first aperture plate and the second aperture plate are provided as an aperture plate in a light beam traveling direction.

4. The lens array according to claim 1, wherein the first thickness of the first aperture plate is defined as tap1 which satisfying the following Expression,
tap1>(r1+r2)×t2/n/(p−r2−r3)
where r1 represents a radius of an opening of each round hole in the first aperture plate close to the first lens array plate, r2 represents a radius of an opening of each round hole in the first aperture plate close to the second lens array plate, r3 represents a radius of an opening of each round hole in the second aperture plate close to the second lens array plate, t2 represents a smallest thickness in the optical axis direction of a portion between the plurality of second lenses in the second lens array plate, n represents a refractive index of the first lens array plate, and p represents a distance between neighboring vertexes of the plurality of first lenses adjacent in the first lens array plate.

5. A contact image sensor comprising:
an erecting and unity-magnifying lens array;
a light source that emits an illuminating light beam illuminating an original document; and
a light-emitting device that receives a light beam reflected by the original document and guided by the erecting and unity-magnifying lens array,
wherein the erecting and unity-magnifying lens array includes a first lens array plate that has a plurality of first lenses, of which exit surfaces are convex, arranged in a direction perpendicular to an optical axis,
a second lens array plate that has a plurality of second lenses, of which entrance surfaces and the exit surfaces are convex, arranged in the direction perpendicular to the optical axis so as to correspond to the plurality of first lenses and that has a light beam emitted from the exit surface of each lens of the first lens array plate be incident thereon,
a third lens array plate that has a plurality of third lenses, of which the entrance surfaces are convex, arranged in the direction perpendicular to the optical axis so as to correspond to the plurality of first lenses,
a first aperture plate that has a plurality of round holes formed therein to correspond to the plurality of first lenses and the plurality of second lenses, that is disposed between the first lens array plate and the second lens array plate, and that has a first thickness, and
a second aperture plate that has a plurality of round holes formed therein to correspond to the plurality of second lenses and the plurality of third lenses, that is disposed close to the exit surface of the second lens array plate, that is disposed so that vertexes of the exit surfaces of the plurality of second lenses are located inside the plurality of round holds, and that has a second thickness smaller than the first thickness.

6. The sensor according to claim 5, wherein the plurality of first lenses in the first lens array plate each have a planar entrance surface.

7. The sensor according to claim 5, wherein only the first aperture plate and the second aperture plate are provided as an aperture plate in a light beam traveling direction.

8. The sensor according to claim 5, wherein the first thickness of the first aperture plate is defined as tap1 which satisfying the following Expression,
tap1>(r1+r2)×t2/n/(p−r2−r3)
where r1 represents a radius of an opening of each round hole in the first aperture plate close to the first lens array plate, r2 represents a radius of an opening of each round hole in the first aperture plate close to the second lens array plate, r3 represents a radius of an opening of each round hole in the second aperture plate close to the second lens array plate, t2 represents a smallest thickness in the optical axis direction of a portion between the plurality of second lenses in the second lens array plate, n represents a refractive index of the first lens array plate, and p represents a distance between neighboring vertexes of the plurality of first lenses adjacent in the first lens array plate.

9. An erecting and unity-magnifying lens array comprising:
a first lens array plate that has a plurality of first lenses arranged in a direction perpendicular to an optical axis;
a second lens array plate that has a plurality of second lenses, of which entrance surfaces and exit surfaces are convex, arranged in the direction perpendicular to the optical axis so as to correspond to the plurality of first lenses and that has a light beam emitted from the exit surface of each lens of the first lens array plate be incident thereon;
a third lens array plate that has a plurality of third lenses arranged in the direction perpendicular to the optical axis so as to correspond to the plurality of first lenses; and
a first aperture plate that has a plurality of round holes formed therein to correspond to the plurality of first lenses and the plurality of second lenses and that is disposed downstream in a light beam traveling direction of the first lens array plate with a predetermined distance interposed between a peripheral edge of each exit surface of the plurality of first lenses and the first aperture plate, in which a radius of each opening of the plurality of round holes close to the first lens array plate is smaller than a radius of the peripheral edge of the exit surface of each first lens.

10. The lens array according to claim 9, wherein the exit surface of each first lens is convex, and the radius of the peripheral edge on the exit surface of each first lens is defined as r4 which satisfying the following Expression,
r4>t3×(r2+r1)/tap1+r1
where t3 represents a distance between the peripheral edge on the exit surface of each first lens and the first aperture plate, r2 represents a radius of an opening of each round hole in the first aperture plate close to the second lens array plate, r1 represents a radius of an opening of each round hole in the first aperture plate close to the first lens array plate, and tap1 represents the first thickness.

11. The lens array according to claim 9, wherein the exit surface of each first lens is convex, and a radius of a peripheral edge on the entrance surface of each first lens is defined as r4 which satisfying the following Expression,
r4>(t4/n+t3)×(r2+r1)/tap1+r1
where t4 represents a distance between the peripheral edge on the entrance surface of each first lens and the exit surface of the first lens, n represents a refractive index of the first lens array plate, t3 represents a distance between the exit surface of each first lens and the first aperture plate, r2 represents a radius of an opening of each round hole in the first aperture plate close to the second lens array plate, r1 represents a radius of an opening of each round hole in the first aperture plate close to the first lens array plate, and tap1 represents the first thickness.
